(19) United States
(12) Patent Application Publication
(10) Pub. No.: US 2026/0188221 A1
(43) Pub. Date: Jul. 2, 2026

(54) DISPLAY DEVICE AND DRIVING METHOD OF THE SAME

(71) Applicant: LG Display Co., Ltd., Seoul (KR)

(72) Inventors: Jin-Hyun Jung, Paju-si (KR); SangHo Yu, Paju-si (KR)

(73) Assignee: LG Display Co., Ltd., Seoul (KR)

(21) Appl. No.: 19/314,923

(22) Filed: Aug. 29, 2025

(30) Foreign Application Priority Data
Dec. 26, 2024 (KR) 10-2024-0196591

(51) Int. Cl. G09G 3/3233; G09G 3/3266

(52) U.S. Cl. CPC G09G 3/3233; G09G 3/3266; G09G 2300/0842; G09G 2320/0233

(57) ABSTRACT

A display device including a display panel including a plurality of sub-pixels; a data driving circuit configured to supply data voltages to the plurality of sub-pixels; and a controller configured to sense the plurality of sub-pixels and obtain first compensation data including first compensation values for compensating characteristic values of each of the plurality of sub-pixels based on the sensed plurality of sub-pixels; detect edge information about an edge where a difference between first compensation values positioned in a same column across adjacent lines changes beyond a threshold; generate second compensation data including second compensation values generated based on the edge information and the first compensation values; and supply compensation data voltages to the plurality of sub-pixels based on the second compensation data and the edge information.

### CROSS REFERENCE TO RELATED APPLICATION

This application claims priority to Korean Patent Application No. 10-2024-0196591, filed in the Republic of Korea on Dec. 26, 2024, the entire contents of which are hereby expressly incorporated by reference into the present application.

### BACKGROUND

### Field of the Invention

The present disclosure relates to a display device and a driving method of the same.

### Discussion of the Related Art

As the information society advances, the demand for various types of display devices capable of displaying images is increasing. Various types of display devices, such as liquid crystal displays (LCDs) and organic light-emitting displays (OLEDs), are being utilized.

Among these display devices, the organic light-emitting displays (OLEDs) which utilize self-emitting organic light-emitting diodes, offer advantages such as fast response speed, high contrast ratio, improved luminous efficiency, high luminance, and wide viewing angles. Such an OLED includes a plurality of sub-pixels arranged in a display panel, each provided with an organic light-emitting diode. By controlling the current flowing through the organic light-emitting diodes, the OLED causes the organic light-emitting diodes to emit light and adjust the luminance of each sub-pixel, thereby displaying an image.

Also, each sub-pixel in the display panel of a display device includes a light-emitting device and a driving transistor for driving the device. However, the characteristic value of the driving transistor in each sub-pixel can change over time during the operation of the display panel or vary due to differences in the driving time among sub-pixels.

As a result, luminance deviation (luminance non-uniformity) can occur among sub-pixels, leading to a deterioration in image quality. To address luminance deviation among sub-pixels, sensing and compensation technologies are used to detect and compensate for variations in the characteristic values of the driving transistors.

### SUMMARY

Accordingly, an object of the present invention is to address the above-noted and other problems.

Another object of the present disclosure is to provide a display device that operates in units of multiple sub-pixels arranged in at least two lines within a display panel and a driving method thereof.

Still another object of the present disclosure is to provide a display device that generates compensation data applied to multiple sub-pixels arranged in at least two lines or in a single line within a display panel, and a driving method thereof.

To achieve these and other advantages and in accordance with the purpose of the present invention, as embodied and broadly described herein, the present invention provides in one aspect a display device including a display panel in which multiple sub-pixels are arranged; a data driving circuit that supplies data voltages to the multiple sub-pixels; and a controller that controls the data driving circuit. The controller senses the multiple sub-pixels to obtain first compensation data, which includes first compensation values that compensate for the characteristic values of each of the multiple sub-pixels. The controller detects edge information that includes information about an edge where at least one of the first compensation values changes beyond a threshold value. The controller generates second compensation data, which includes second compensation values generated based on the edge information and the first compensation values, and supplies a compensated data voltage based on the second compensation data and the edge information.

In another aspect, the present disclosure provides a display device having a display area where multiple sub-pixels are arranged in units of lines and an image is displayed; a non-display area that defines the periphery of the display area; a gate driving circuit disposed in the non-display area that supplies scan signals to multiple sub-pixels in units of at least two lines or a single line; and a controller that controls the gate driving circuit. Further, as multiple frames of an image are displayed, the operation period of the controller alternates between multiple valid periods in which the image is displayed during the multiple frame periods and multiple blank periods in which the image is not displayed during the multiple frame periods. Also, during a first valid period in which scan signals are supplied to all lines of the multiple sub-pixels, if the gate driving circuit has supplied scan signals on a per-line basis, the controller extends the first blank period by a predetermined first duration and delays the start time of a second valid period that follows the first blank period.

In still another aspect, the present disclosure provides a driving method for a display device including a display panel in which multiple sub-pixels are arranged, a data driving circuit that supplies data voltages to the multiple sub-pixels, a gate driving circuit that supplies scan signals, and a controller that controls the data driving circuit. The method includes sensing the multiple sub-pixels to obtain first compensation data, which includes first compensation values that compensate for the characteristic values of each of the multiple sub-pixels; detecting edge information that includes information about an edge where at least one of the first compensation values changes beyond a threshold value; generating second compensation data that includes second compensation values generated based on the edge information and the first compensation values; and supplying a compensated data voltage based on the second compensation data and the edge information.

According to the embodiments of the present disclosure, a display device and a driving method thereof can be provided in which compensation data is generated separately for application to a single line or at least two lines in the display panel, based on differences in the compensation values obtained through sensing multiple sub-pixels. Further, the display device operates in a low-power mode by driving multiple sub-pixels in units of at least two lines or a single line within the display panel, thereby adjusting the blank period.

Further scope of applicability of the present invention will become apparent from the detailed description given hereinafter. However, the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present disclosure will be more fully understood from the following detailed description and the accompanying drawings. The detailed description and the drawings are provided solely for explanatory purposes and are not intended to limit the scope of the present disclosure.

FIG. 1 is a system diagram of a display device according to various embodiments of the present disclosure.

FIG. 2 is a diagram illustrating a compensation circuit of a display device according to various embodiments of the present disclosure.

FIG. 3 is a diagram showing first compensation data that includes first compensation values generated by sensing multiple sub-pixels according to various embodiments of the present disclosure.

FIG. 4 is a diagram illustrating edge information that includes information about an edge according to various embodiments of the present disclosure.

FIG. 5 is a diagram showing DFR compensation data that compensates multiple sub-pixels driven in units of at least two lines according to various embodiments of the present disclosure.

FIG. 6 is a diagram illustrating second compensation data that compensates multiple sub-pixels driven in units of at least two lines or a single line according to various embodiments of the present disclosure.

FIG. 7 is a chart illustrating driving periods of a display device in which multiple sub-pixels are driven in single-line units according to various embodiments of the present disclosure.

FIG. 8 is a chart illustrating driving periods of a display device in which multiple sub-pixels are driven in units of at least two lines according to various embodiments of the present disclosure.

FIG. 9 is a chart illustrating driving periods of a display device in which multiple sub-pixels are driven in single-line or at least two-line units according to various embodiments of the present disclosure.

FIG. 10 is a flowchart illustrating a compensation method for a display device according to various embodiments of the present disclosure.

### DETAILED DESCRIPTION

In the following description of examples or embodiments of the present invention, reference will be made to the accompanying drawings in which it is shown by way of illustration specific examples or embodiments that can be implemented, and in which the same reference numerals and signs can be used to designate the same or like components even when they are shown in different accompanying drawings from one another. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” can be used herein to describe elements of the present invention. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element can be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms can be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that can be caused by various factors (e.g., process factors, internal or external impact, noise, etc.) even when a relevant description is not specified. Further, the term “can” fully encompasses all the meanings of the term “can”.

Hereinafter, various embodiments of the present disclosure will be described in detail with reference to the accompanying drawings.

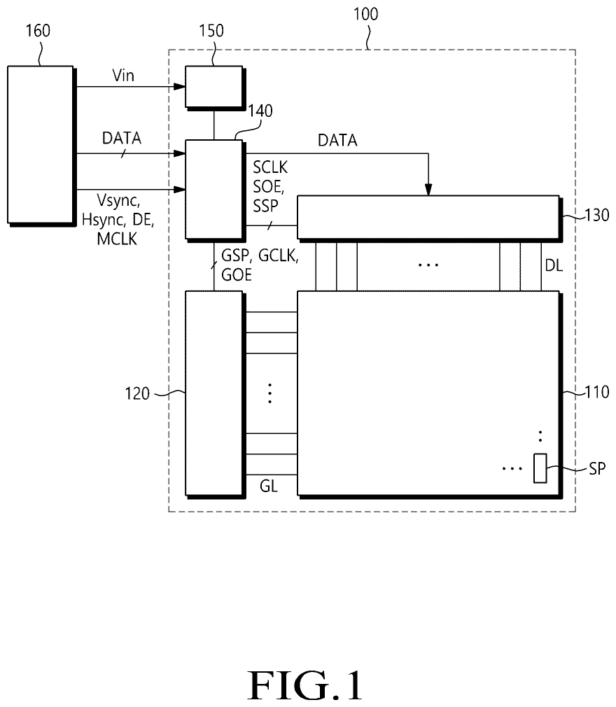

FIG. 1 is a system diagram of a display device 100 according to an embodiment of the present disclosure. Referring to FIG. 1, the display device 100 includes a display panel 110 in which multiple gate lines GL and data lines DL are connected and multiple sub-pixels SP are arranged in a matrix form; a gate driving circuit 120 that drives multiple gate lines GL; a data driving circuit 130 that supplies data voltages through multiple data lines DL; a controller 140 that controls the gate driving circuit 120 and the data driving circuit 130; and a power management circuit 150.

Further, the display panel 110 displays images based on a scan signal and a light-emission control signal transmitted from the gate driving circuit 120 through multiple gate lines GL, and a data voltage transmitted from the data driving circuit 130 through multiple data lines DL. For a liquid crystal display (LCD), the display panel 110 includes a liquid crystal layer formed between two substrates and can operate in any known mode, such as Twisted Nematic (TN) mode, Vertical Alignment (VA) mode, In-Plane Switching (IPS) mode, or Fringe Field Switching (FFS) mode. For an organic light-emitting display (OLED), the display panel 110 can be implemented in a top emission mode, a bottom emission mode, or a dual emission mode.

In addition, the display panel 110 can have multiple pixels arranged in a matrix form, where each pixel includes sub-pixels SP of different colors, such as white sub-pixels, red sub-pixels, green sub-pixels, and blue sub-pixels. Each sub-pixel SP can be defined by multiple data lines DL and multiple gate lines GL. Also, a single sub-pixel SP can include a thin-film transistor (TFT) formed at the intersection of a data line DL and a gate line GL, a light-emitting device such as an organic light-emitting diode (OLED) that stores data voltage, and a storage capacitor electrically connected to the light-emitting device to maintain the voltage.

For example, if the display device 100 has a resolution of 2,160×3,840 and includes four types of sub-pixels SP—white W, red R, green G, and blue B—there are 2,160 gate lines GL and 3,840 data lines DL connected to each of the four sub-pixels WRGB. As a result, a total of 3,840×4=15,360 data lines DL are provided, and sub-pixels SP can be positioned at the intersections of the gate lines GL and the data lines DL. In addition, the gate driving circuit 120 is controlled by the controller 140 and sequentially outputs scan signals to multiple gate lines GL arranged in the display panel 110, thereby controlling the driving timing of multiple sub-pixels SP.

In a display device 100 with a resolution of 2,160×3,840, when scan signals are sequentially output from the first gate line GL to the 2,160th gate line, this can be referred to as 2,160-phase driving. Alternatively, when scan signals are sequentially output from the first to the fourth gate lines and then sequentially output from the fifth to the eighth gate lines, such that scan signals are sequentially output in units of four gate lines GL, this is referred to as 4-phase driving. That is, when scan signals are sequentially output in units of N gate lines GL, it can be referred to as N-phase driving.

In this instance, the gate driving circuit 120 can include one or more gate driving integrated circuits (GDIC). Depending on the driving method, the gate driving circuit 120 can be positioned on only one side of the display panel 110 or on both sides. Alternatively, the gate driving circuit 120 can be embedded in the bezel region of the display panel 110 and implemented in a Gate In Panel (GIP) structure.

In addition, the data driving circuit 130 receives image data DATA from the controller 140 and converts the received image data DATA into an analog form of data voltage. Then, in synchronization with the timing when the scan signal is applied through the gate lines GL, the data voltage is output to each data line DL, so that each subpixel SP connected to the data line DL displays a light-emitting signal with a brightness corresponding to the data voltage.

Similarly, the data driving circuit 130 can include one or more source driving integrated circuits (SDIC). In particular, the source driving integrated circuit (SDIC) can be connected to the bonding pad of the display panel 110 via a Tape Automated Bonding (TAB) method or a Chip On Glass (COG) method, or it can be directly placed on the display panel 110. In some instances, each source driving integrated circuit (SDIC) can be integrated and arranged in the display panel 110. Additionally, each source driving integrated circuit (SDIC) can be implemented using a Chip On Film (COF) method. In this instance, each source driving integrated circuit (SDIC) is mounted on a circuit film and electrically connected to the data lines DL of the display panel 110 via the circuit film.

Further, the controller 140 supplies various control signals to the gate driving circuit 120 and the data driving circuit 130 and controls their operation. Specifically, the controller 140 controls the gate driving circuit 120 to output scan signals according to the timing of each frame and, at the same time, transmits externally received image data DATA to the data driving circuit 130.

In addition, the controller 140 receives various timing signals, including a vertical synchronization signal (Vsync), a horizontal synchronization signal (Hsync), a data enable signal (DE), and a main clock (MCLK), from an external host system 160, along with the image data DATA. Also, the host system 160 can be one of a television (TV) system, a set-top box, a navigation system, a personal computer (PC), a home theater system, a mobile device, or a wearable device.

Accordingly, the controller 140 generates control signals based on the timing signals received from the host system 160 and transmits the signals to the gate driving circuit 120 and the data driving circuit 130. For example, to control the gate driving circuit 120, the controller 140 outputs various gate control signals, including a gate start pulse GSP, a gate clock GCLK, and a gate output enable signal GOE. Here, the gate start pulse GSP controls the timing at which one or more gate driving integrated circuits GDIC constituting the gate driving circuit 120 start operation. Also, the gate clock GCLK is a clock signal commonly input to one or more gate driving integrated circuits GDIC and controls the shift timing of the scan signal. Further, the gate output enable signal GOE designates the timing information for one or more gate driving integrated circuits GDIC.

Additionally, the controller 140 outputs various data control signals, including a source start pulse (SSP), a source sampling clock (SCLK), and a source output enable signal (SOE), to control the data driving circuit 130. Here, the source start pulse (SSP) controls the timing at which one or more source driving integrated circuits (SDIC) constituting the data driving circuit 130 begin data sampling. Also, the source sampling clock (SCLK) is a clock signal that controls the timing of sampling data in the source driving integrated circuit (SDIC). Further, the source output enable signal (SOE) controls the output timing of the data driving circuit 130.

In addition, the display device 100 can include a power management circuit 150, which supplies various voltages or currents to the display panel 110, the gate driving circuit 120, and the data driving circuit 130 etc., or controls the various voltages or currents to be supplied. In more detail, the power management circuit 150 adjusts the DC input voltage Vin supplied from the host system 160 and generates the power required to drive the display panel 110, the gate driving circuit 120, and the data driving circuit 130.

As shown in FIG. 1, subpixels SP are located at intersections of the gate lines GL and data lines DL, and each subpixel SP can include a light-emitting device. For example, in an organic light-emitting display, each subpixel SP includes a light-emitting device such as an organic light-emitting diode and can display images by controlling the current flowing through the light-emitting device according to the data voltage.

Further, the display device 100 can be of various types, such as a LCD, OLED, or a plasma display panel (PDP). The display device 100 can be driven in units of multiple subpixels SP arranged within a single line. In this instance, the gate driving circuit 120 can supply a turn-on level scan signal in units of a single line. Accordingly, when data voltages are sequentially supplied from the data driving circuit 130 in units of a single line, an image can be displayed. Hereinafter, this driving method can be referred to as normal driving.

In addition, the display device 100 can be driven in units of multiple subpixels SP arranged within two or more lines. In this instance, the gate driving circuit 120 can supply a turn-on level scan signal in units of two or more lines. Accordingly, when data voltages are sequentially supplied from the data driving circuit 130 in units of two or more lines, images can be displayed. Hereinafter, this driving method can be referred to as DFR driving (Double Frame Rate Driving).

In addition, the display device 100 can be selectively driven in units of multiple subpixels SP arranged in two or more lines or a single line. In this instance, the gate driving circuit 120 can supply a turn-on level scan signal either in units of a single line or in units of two or more lines. Accordingly, when data voltages are sequentially supplied from the data driving circuit 130 in units of either a single line or two or more lines, images can be displayed. Hereinafter, this driving method can be referred to as Dynamic DFR driving (Dynamic Double Frame Rate Driving).

When the display device 100 operates in DFR driving or Dynamic DFR driving mode, the same data voltage can be supplied to every two lines. Additionally, the same data voltage can be supplied in units of two or more lines.

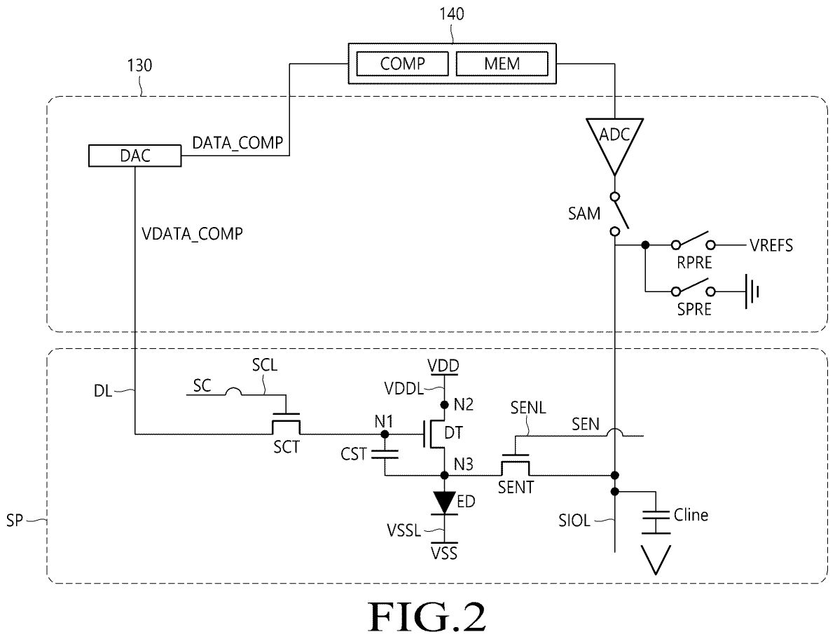

Next, FIG. 2 is a diagram illustrating an example of a compensation circuit for the display device 100 according to various embodiments of the present disclosure. Referring to FIG. 2, the display device 100 senses changes in the characteristic values of each driving transistor DT to compensate for the sensed characteristic value deviations of the driving transistor DT.

That is, the compensation circuit of the display device 100 can include configurations for sensing changes in the characteristic values of the driving transistor DT within the subpixel SP during a sensing period, for subpixels SP having a 3T1C structure or a modified structure. In FIG. 2, the compensation circuit of the display device 100 can include the subpixel SP, the data driving circuit 130, and the controller 140.

As shown in FIG. 2, the subpixel SP includes a driving transistor DT that controls the electrical connection between a second node N2 and a third node N3 according to the voltage of a first node N1, a scan transistor SCT that is controlled by a scan signal SC input from a scan signal line SCL, a sensing transistor SENT that is controlled by a sensing signal SEN input from a sensing signal line SENL, and a light-emitting device ED. In addition, the data driving circuit 130 can include switch circuits SAM, SPRE, and RPRE that control sensing driving, an analog-to-digital converter ADC connected to the controller 140, and an output circuit DAC including a digital-to-analog converter and an output buffer.

Further, the display device 100 can sense the voltage of a sensing line SIOL during a sensing period (or sensing duration) and determine the characteristic value or the change in the characteristic value of the driving transistor DT within the subpixel SP from the sensed voltage. Specifically, in the display device 100, the change in the characteristic value of the driving transistor DT can be reflected in the voltage of the third node N3 of the driving transistor DT. When the sensing transistor SENT is in a turn-on state, the voltage of the third node N3 of the driving transistor DT can correspond to the voltage of the sensing line SIOL.

Additionally, the voltage of the third node N3 of the driving transistor DT can charge a line capacitor Cline on the sensing line SIOL, and the charged line capacitor Cline can cause the sensing line SIOL to have a voltage corresponding to the voltage of the third node N3 of the driving transistor DT. Further, the compensation circuit of the display device 100 can control the on/off states of the scan transistor SCT and the sensing transistor SENT and control the supply of a sensing driving data voltage and a sensing driving reference voltage VREFS, thereby driving the third node N3 of the driving transistor DT to be in a state that reflects the characteristic value change of the driving transistor DT.

Further, the analog-to-digital converter ADC can measure the voltage of the sensing line SIOL, which corresponds to the voltage of the third node N3 of the driving transistor DT, and convert it into a digital value. Hereinafter, the converted digital values can correspond to first compensation values. Alternatively, the converted digital values that have been modified to compensate for the characteristic value of the driving transistor can correspond to the first compensation values. Also, the switch circuits SAM, SPRE, and RPRE can control the electrical connection between the sensing line SIOL and other components for characteristic value sensing.

In addition, the switch circuits SAM, SPRE, and RPRE that control sensing driving can include a sensing reference switch RPRE that controls the connection between each sensing line SIOL and a sensing reference voltage node to which the sensing reference voltage VREFS is supplied, a display reference switch SPRE that controls the connection between the sensing line SIOL and the base voltage, and a sampling switch SAM that controls the connection between each sensing line SIOL and the analog-to-digital converter ADC. In this instance, the sensing reference switch RPRE and the display reference switch SPRE can be separately provided or integrated into a single component. Further, the sensing driving reference voltage VREFS and the base voltage can have the same voltage value or different voltage values. If necessary, the display reference switch can be turned on in order to sense the subpixel SP, and input the base voltage to the subpixel SP.

In addition, as shown in FIG. 2, the compensation circuit of the display device 100 includes a controller 140 that stores sensing values output from the analog-to-digital converter ADC or pre-stores reference sensing values and calculates compensation values to compensate for characteristic value deviations by comparing the sensing values with the reference sensing values. The controller 140 can also include a memory MEM and a compensation module COMP.

In more detail, the memory MEM can store a first compensation value corresponding to the sensing value, first compensation data including the first compensation value, a second compensation value generated based on the first compensation value, and second compensation data including the second compensation value. The memory can be configured as DRAM (Dynamic Random Access Memory) or NAND (Negative AND) memory. Also, the compensation module COMP can generate the second compensation value based on the first compensation value. That is, the compensation module COMP can generate second compensation data that includes second compensation values from the first compensation data that includes first compensation values.

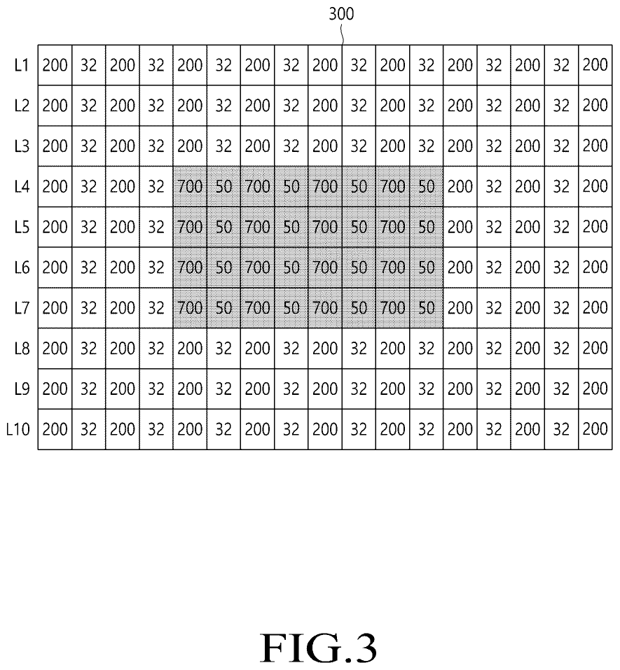

Descriptions of the first compensation value, the first compensation data including the first compensation value, the second compensation value generated based on the first compensation value, and the second compensation data including the second compensation value will be described in more detail with reference to FIG. 3.

In addition, the controller 140 can compensate for image data in the form of a digital signal to be supplied to the data driving circuit 130 using the calculated compensation values (e.g., the first compensation value and the second compensation value) and output the compensated image data DATA_COMP to the data driving circuit 130. Also, the data driving circuit 130 can convert the compensated image data DATA_COMP into a compensated data voltage VDATA_COMP in an analog signal form through the output circuit DAC and output the converted compensated data voltage VDATA_COMP to the data line DL. As a result, characteristic value deviations of the driving transistor DT within the corresponding subpixel SP can be compensated.

When multiple subpixels SP operate in DFR driving or Dynamic DFR driving mode, the compensated image data needs to be modified and applied. In addition, the compensation data including the first compensation value can be referred to as first compensation data. Also, the compensation data including the second compensation value, which is generated based on the first compensation value for DFR driving or Dynamic DFR driving, can be referred to as second compensation data.

Hereinafter, examples of first compensation data, second compensation data, and edge information used to generate the second compensation data will be provided. Additionally, in the following description, a display device 100 in which second compensation data is generated in units of two lines or scan signals are supplied in units of two lines is described. However, other examples are included in which second compensation data is generated or scan signals (or data voltages) are supplied in units of more than two lines.

Next, FIG. 3 is a diagram illustrating first compensation data 300 that includes first compensation values generated by sensing multiple subpixels SP according to various embodiments of the present disclosure. Referring to FIG. 3, the first compensation data 300 can include first compensation values (e.g., 32, 50, 200, 700) within multiple lines L1, L2, L3, L4, L5, L6, L7, L8, L9, and L10. The first compensation values can correspond to sensed values or converted sensed values used to compensate for the different characteristic values of the driving transistors DT in each of the multiple subpixels SP.

In addition, the first compensation data 300 can have a form corresponding to the arrangement of multiple subpixels SP in the display panel 110. For example, the first compensation data 300 corresponding to the lines in which multiple subpixels SP are arranged within the display panel 110 can include multiple lines L1, L2, L3, L4, L5, L6, L7, L8, L9, and L10. If the display panel 110 has a resolution of 2160×3840, the first compensation data can include 3840 lines and 15,360 columns.

When the display device 100 operates in a normal driving mode, the controller 140 can output (or generate) (or store) compensated image data DATA_COMP using the first compensation values of the first compensation data 300. Also, as shown in FIG. 2, the output compensated image data DATA_COMP can be converted into a compensated data voltage VDATA_COMP and supplied to the subpixels SP of the display panel 110 corresponding to the arrangement of the first compensation data 300.

When the display device 100 operates in a DFR driving mode or Dynamic DFR driving mode, the compensated data voltage VDATA_COMP can be supplied in units of two or more lines within the display panel 110. In this instance, to reflect the characteristic values of the driving transistors DT in the multiple subpixels SP within at least two lines, the compensated data voltage VDATA_COMP can be supplied using the second compensation value of one line, which is generated based on representative values from at least two lines in the first compensation data 300. The representative values can include intermediate values or average values generated from the first compensation values of at least two lines.

When representative values are used, bright spots and dark spots can appear on the display panel 110. Hereinafter, examples of edge information obtained to prevent the phenomenon of bright spots and dark spots appearing will be described.

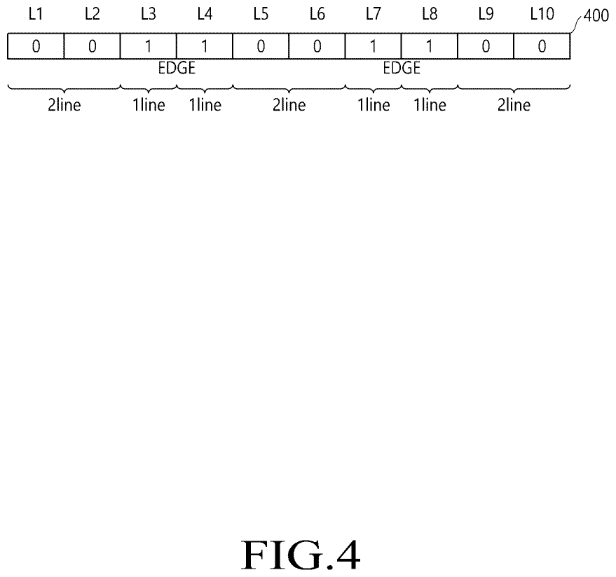

In particular, FIG. 4 is a diagram illustrating edge information 400 that includes information on edges EDGE according to various embodiments of the present disclosure. Referring to FIG. 4, the edge information 400 can include digital information about edges EDGE in the multiple lines L1 to L10 of the first compensation data 300. The operation of detecting edges EDGE can be performed using methods such as Sobel edge detection, Canny edge detection, and Roberts Cross Edge Detection. In this instance, by applying the aforementioned edge detection methods, the size and weight of the mask used to determine position-based weights can be adjusted, and various edge detection techniques known to those skilled in the art can be used. Additionally, the mask can be simplified to utilize the difference values between lines. Hereinafter, a detailed operation of edge detection will be described.

For example, the edge information 400 can include digital information on whether a change exceeding a threshold value has occurred as the first compensation values within the lines of the first compensation data 300 are sequentially compared. If at least one first compensation value in the first compensation data 300 changes beyond the threshold value according to the sequential comparison of lines in the first compensation data 300, it can be referred to as an edge.

When an edge is detected in the lines of the first compensation data 300, the lines where the edge is detected can be assigned a value of 1, while the lines where no edge is detected can be assigned a value of 0. For example, in FIG. 3, the difference value of at least one first compensation value between the first line L1 and the second line L2 (e.g., 0) can be less than the threshold value. Accordingly, an edge is not detected between the first line L1 and the second line L2. In this instance, the edge information 400 of the first line L1 in FIG. 3 can be stored as 0. Additionally, the value of the edge information 400 for the second line L2 in FIG. 3 can be determined based on whether an edge is detected between the second line L2 and the third line L3.

In addition, the difference value of at least one first compensation value between the second line L2 and the third line L3 in FIG. 3 can be less than the threshold value. Accordingly, an edge is not detected between the second line L2 and the third line L3. In this instance, the edge information 400 of the second line L2 in FIG. 3 can be stored as 0.

Additionally, the value of the edge information 400 for the third line L3 in FIG. 3 can be determined based on whether an edge is detected between the third line L3 and the fourth line L4. Also, in the Dynamic DFR driving mode, if the edge information 400 corresponding to the first line L1 and the second line L2 in FIG. 3 has a value of 0, compensation values can be generated for every two lines in the display panel 110, and scan signals SC can be supplied in units of two lines. Also, as shown in FIG. 3, the difference value of at least one first compensation value between the third line L3 and the fourth line L4 in FIG. 3 can be equal to or greater than the threshold value. Accordingly, an edge can be detected between the third line L3 and the fourth line L4. In this instance, the edge information 400 of the third line L3 in FIG. 3 can be stored as 1. Additionally, the edge information 400 of the fourth line L4 in FIG. 3 can be stored as 1 regardless of whether an edge is detected between the fourth line L4 and the fifth line L5. That is, if an edge is detected between at least one of the upper or lower lines, the edge information 400 can have a value of 1.

In the Dynamic DFR driving mode, if the edge information 400 corresponding to the third line L3 and the fourth line L4 in FIG. 3 has a value of 1, compensation values can be generated for each line in the display panel 110, and scan signals SC can be supplied in units of a single line. Also, the difference value of at least one first compensation value between the seventh line L7 and the eighth line L8 in FIG. 3 can be equal to or greater than the threshold value. Accordingly, an edge can be detected between the seventh line L7 and the eighth line L8. In this instance, the edge information 400 of the seventh line L7 in FIG. 3 can be stored as 1. Additionally, the edge information 400 of the eighth line L8 in FIG. 3 can be stored as 1 regardless of whether an edge is detected between other lines.

In addition, in the Dynamic DFR driving mode, if the edge information 400 corresponding to the seventh line L7 and the eighth line L8 in FIG. 3 has a value of 1, compensation values can be generated for each line in the display panel 110, and scan signals can be supplied in units of a single line. That is, in Dynamic DFR driving mode, the display device 100 can generate second compensation data in units of either a single line or two or more lines in the first compensation data 300 based on the edge information 400. If three or more consecutive lines have an edge information value of 0, compensation values can be generated in units of three lines, and scan signals can be supplied accordingly. Additionally, based on the edge information 400 and the second compensation data, the display device 100 can supply the compensated data voltage VDATA_COMP, reflecting the second compensation data, in units of either a single line or two or more lines to the display panel 110.

Further, in the display panel 110, lines corresponding to the first compensation data 300 with an edge information value of 1 can receive the compensated data voltage VDATA_COMP in units of a single line for multiple subpixels SP and can receive scan signals SC. In addition, in the display panel 110, lines corresponding to the first compensation data 300 with an edge information value of 0 can receive the compensated data voltage VDATA_COMP in units of at least two lines for multiple subpixels SP and can receive scan signals SC.

Hereinafter, the process of supplying the compensated data voltage VDATA_COMP and scan signals SC to multiple subpixels SP in units of n lines can be referred to as driving multiple subpixels SP in units of n lines. Here, n is a natural number. Edge information 400 obtained using sensing values can cause issues such as unnecessary edge detection or failure to detect necessary edges if abnormal pixels exist.

Accordingly, the display device 100 can acquire abnormal pixel information through at least one of the following analyses: optical analysis using an inspection camera or a microlens to detect pixel positions displaying abnormal luminance, electrical analysis to identify pixel positions with abnormal current or voltage response speeds, image analysis using specific patterns displayed on the display panel 110 to identify the location of pixels displaying abnormal luminance, and thermal image analysis to detect pixels with abnormal heat emission patterns. In addition, the abnormal pixel information can be obtained by applying a constant voltage to the pixels and using digital values acquired through an analog-to-digital converter. The abnormal pixel information can also be obtained by storing detected abnormal pixels in the display device 100 based on user viewing. Further, the abnormal pixel information can include data on pixels that have been normalized through the repair process. Normalized pixels can refer to pixels that were detected as defective during the repair process. However, the analysis methods described are not limited, and various other methods can be used to obtain abnormal pixel information.

Abnormal pixel information (or defective pixel information) can include location information, color information, and pixel classification information (e.g., dark spot information, bright spot information, and anomaly information). Based on the abnormal pixel information, the location of the abnormal (or defective) pixel can be determined. If abnormal pixels exist in a line, the sensing values (or first compensation values) for that line can be inaccurate.

Accordingly, edge detection between lines can be inaccurate. Due to the inaccuracy in edge detection between lines, lines containing abnormal pixels may need to be driven in units of a single line, regardless of the edge information 400. To enable single-line driving, the edge information 400 of lines containing abnormal pixels needs to be changed to a value of 1. Accordingly, regardless of edge detection between the lines of the first compensation data 300, any edge information value of 0 in a line containing abnormal pixels can be changed to 1.

For example, if an abnormal pixel exists in the first line L1 with edge information of 0, the edge information 400 corresponding to the first line L1 in FIG. 3 can be changed to a value of 1. Accordingly, the line in the display panel 110 corresponding to the first line L1 in FIG. 3 can be driven in units of a single line.

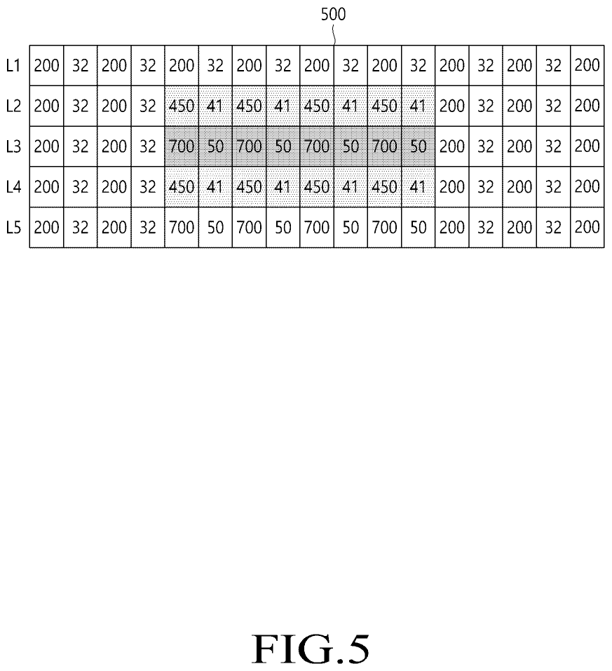

Next, FIG. 5 is a diagram illustrating DFR compensation data that compensates multiple subpixels SP driven in units of two or more lines according to various embodiments of the present disclosure. The DFR compensation data 500 can be generated by sequentially pairing the lines of the first compensation data 300 in units of two or more lines.

Referring to FIG. 5, the DFR compensation data 500 can include multiple DFR compensation values (e.g., 32, 41, 50, 200, 450, 700) within multiple lines L1, L2, L3, L4, and L5. The controller 140 can generate representative values of the first compensation values in at least two lines in the first compensation data 300 as DFR compensation values within one line of the DFR compensation data 500.

For example, the representative values of the first compensation values in the third line L3 and the fourth line L4 in FIG. 3 can be generated as DFR compensation values in the second line L2 of FIG. 5. For example, the DFR compensation value of 450 in the fifth column of the second line L2 in FIG. 5 is a value generated by averaging the first compensation value of 200 in the fourth column of the third line L3 in FIG. 3 and the first compensation value of 700 in the fourth column of the fourth line L4 in FIG. 3.

According to the aforementioned method, the number of lines in the generated DFR compensation data 500 can be half the number of lines in the first compensation data 300. According to the DFR driving method, when the DFR compensation data 500 in one line is used to compensate multiple subpixels SP in at least two lines within the display panel 110, the multiple subpixels SP in one line can be compensated based on values exceeding the required compensation value, while the multiple subpixels SP in another line can be compensated based on values lower than the required compensation value.

When multiple subpixels SP are compensated based on values exceeding the required compensation value, uniform luminance may not be maintained in the image, resulting in a bright spot phenomenon where bright points appear. Also, when multiple subpixels SP are compensated based on values lower than the required compensation value, uniform luminance may not be maintained in the image, resulting in a dark spot phenomenon where dark points appear.

To prevent the aforementioned bright spot or dark spot phenomenon, according to the Dynamic DFR driving method, the display device 100 can drive the lines where bright spots and dark spots are expected in units of a single line, while driving other lines in units of two or more lines. In addition, the lines where bright spots and dark spots are expected can be determined by sequentially comparing the compensation values between lines (i.e., detecting edges). For example, in the DFR driving method, the third line L3 and the fourth line L4 in FIG. 3 can be compensated using the DFR compensation values in the second line L2 of FIG. 5. In this instance, the line in the display panel 110 corresponding to the third line L3 in FIG. 3 can be overcompensated, causing bright spots, while the line in the display panel 110 corresponding to the fourth line L4 in FIG. 3 can be undercompensated, causing dark spots.

To prevent the occurrence of bright spots and dark spots, multiple subpixels SP can be controlled to be driven in units of either a single line or two or more lines, according to the aforementioned method. Hereinafter, second compensation data for compensation based on selective line driving can be illustrated.

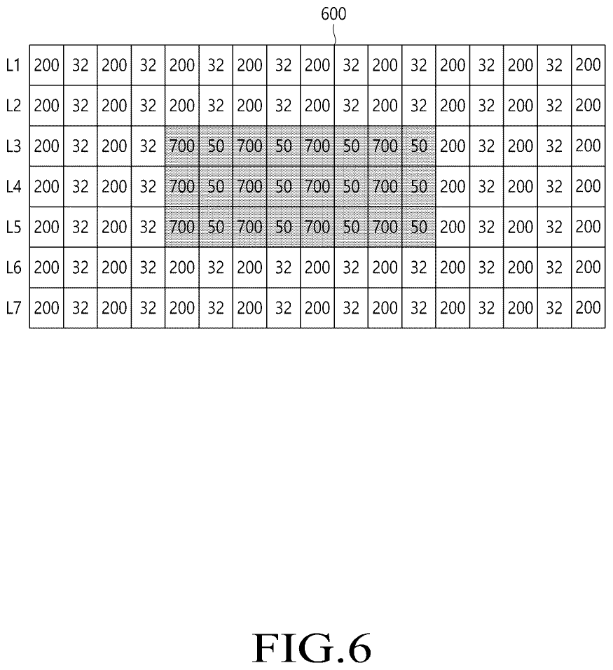

In particular, FIG. 6 is a diagram illustrating second compensation data 600 that compensates multiple subpixels SP driven in units of at least two lines or a single line, according to various embodiments of the present disclosure. Referring to FIG. 6, the second compensation data 600 can include multiple second compensation values within multiple lines L1, L2, L3, L4, L5, L6, and L7.

Further, the second compensation data 600 can be generated by sequentially pairing the lines of the first compensation data 300 when no edge is present in at least two lines in the first compensation data 300. Additionally, when an edge is present in at least two lines in the first compensation data 300, the pairing can be released, and the second compensation data 600 can be generated in units of a single line. After the pairing is released and the second compensation values for one line are generated, the second compensation data 600 can be paired and generated from the next line.

In addition, as described above, the controller 140 can obtain the edge information 400 by detecting an edge where at least one first compensation value changes beyond the threshold value among the first compensation values. The controller 140 can also generate second compensation values based on the edge information 400 and the first compensation values. Additionally, the method by which the second compensation values are applied to the display panel 110 can also be changed according to the edge information 400.

For example, if the difference in the first compensation values between the first line L1 and the second line L2 in FIG. 3 (e.g., 0) does not change beyond the threshold value, an edge is not detected. Since no edge is detected between the first line L1 and the second line L2 in FIG. 3, the second compensation values of the first line L1 in FIG. 6 can be generated as representative values of the first compensation values within the first line L1 and the second line L2 in FIG. 3. In this instance, the second compensation values of the first line L1 in FIG. 6 can be used to compensate multiple subpixels SP arranged in the lines of the display panel 110 corresponding to the first line L1 and the second line L2 in the first compensation data 300.

Hereinafter, compensation or the method used for compensation can refer to modifying the data voltage supplied to the subpixel SP using compensation values (first compensation value, second compensation value) that reflect the characteristic value of the driving transistor DT within the subpixel SP or changes in the characteristic value. For example, if the difference in the first compensation values between the third line L3 and the fourth line L4 in FIG. 3 changes beyond the threshold value, an edge can be detected. Once an edge is detected, the second compensation values of the second line L2 in FIG. 6 can be generated using the first compensation values of the third line L3 in FIG. 3. In addition, the second compensation values of the third line L3 in FIG. 6 can be generated using the first compensation values of the fourth line L4 in FIG. 3.

In this instance, the second compensation values of the second line L2 in FIG. 6 can be used to compensate multiple subpixels SP arranged in the lines of the display panel 110 corresponding to the third line L3 in FIG. 3. Also, the second compensation values of the third line L3 in FIG. 6 can be used to compensate multiple subpixels SP arranged in the lines of the display panel 110 corresponding to the fourth line L4 in FIG. 3.

For example, if the difference in the first compensation values between the fifth line L5 and the sixth line L6 in FIG. 3 (e.g., 0) does not change beyond the threshold value, an edge is not detected. If no edge is detected, the second compensation values of the fourth line L4 in FIG. 6 can be generated as representative values of the first compensation values within the fifth line L5 and the sixth line L6 in FIG. 3. In this instance, the second compensation values of the fourth line L4 in FIG. 6 can be used to compensate multiple subpixels SP arranged in the lines of the display panel 110 corresponding to the fifth line L5 and the sixth line L6 in the first compensation data 300.

Also, if the difference in the first compensation values between the seventh line L7 and the eighth line L8 in FIG. 3 (e.g., 500) does change beyond the threshold value, an edge is not detected. If an edge is detected, the second compensation values of the fifth line L5 in FIG. 6 can be generated as the first compensation values of the seventh line L7 in FIG. 3. The second compensation values of the sixth line L6 in FIG. 6 may be generated as the first compensation values of the eighth line L8 in FIG. 3 In addition, the second compensation values of the fifth line L5 in FIG. 6 can be used to compensate multiple subpixels SP arranged in the lines of the display panel 110 corresponding to the seventh line L7 in the first compensation data 300. The second compensation values of the sixth line L6 in FIG. 6 may be used to compensate multiple subpixels SP arranged in the lines of the display panel 110 corresponding to the eighth line L8 in the first compensation data 300.

If the difference in the first compensation values between the ninth line L9 and the tenth line L10 in FIG. 3 (e.g., 0) does not change beyond the threshold value, an edge is not detected. If no edge is detected, the second compensation values of the seventh line L7 in FIG. 6 can be generated as representative values of the first compensation values within the ninth line L9 and the tenth line L10 in FIG. 3. In this instance, the second compensation values of the seventh line L7 in FIG. 6 can be used to compensate multiple subpixels SP arranged in the lines of the display panel 110 corresponding to the ninth line L9 and the tenth line L10 in the first compensation data 300.

Further, the display device 100 can acquire abnormal pixel information (or point defect information) that includes location data of defective pixels. Accordingly, the controller 140 can detect the location of defective pixels. Also, the second compensation values can be generated using the location of defective pixels and the first compensation values.

For example, if defective subpixels exist within a line of multiple subpixels SP corresponding to a specific line in the first compensation data 300, the second compensation values of that specific line can be generated using the first compensation values or predetermined compensation values. In this instance, the generated second compensation values can be used to compensate multiple subpixels SP arranged in the lines of the display panel 110 corresponding to the specific line. The specific line can be driven in units of a single line or two or more lines.

In addition, the number of lines in the second compensation data 600, which includes the second compensation values generated according to the aforementioned method, can be between half the number of lines in the first compensation data 300 and the number of lines in the first compensation data 300. That is, as shown in FIGS. 5 and 6, the matrix form of the compensation data 500 and 600 is smaller in size than the matrix form 300 shown in FIG. 3. Thus, less memory can be advantageously used and multiple lines of pixels can be selectively controlled.

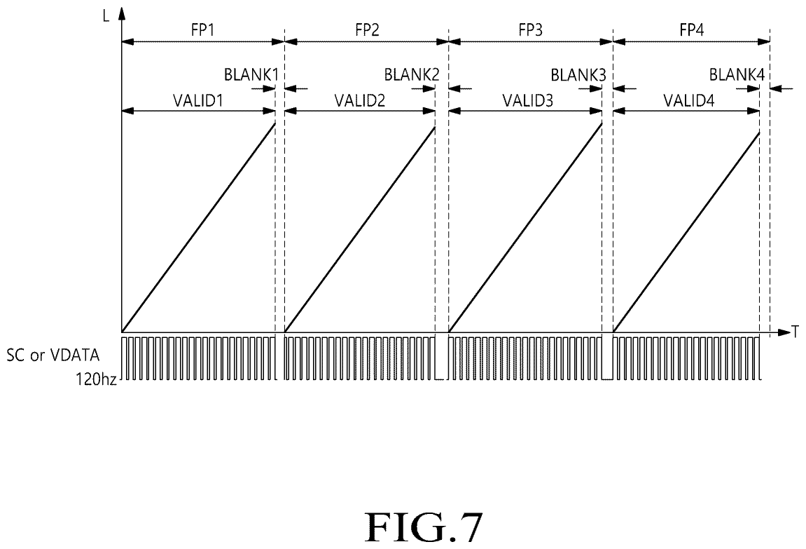

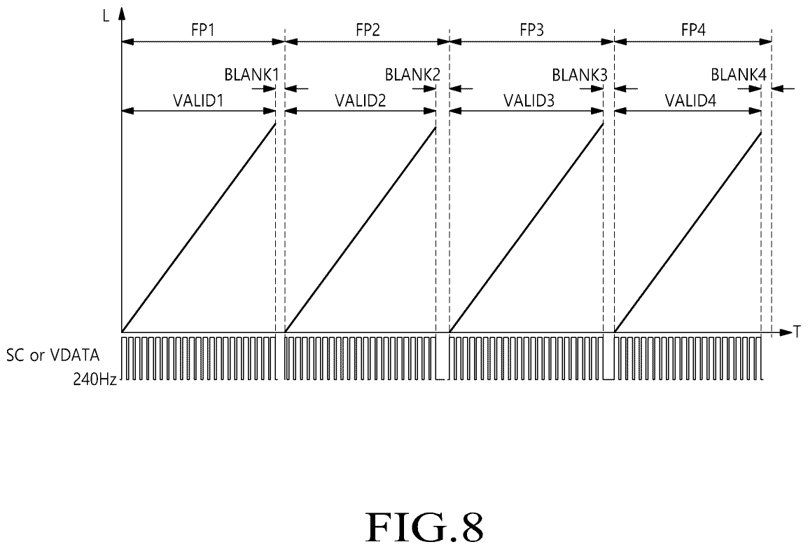

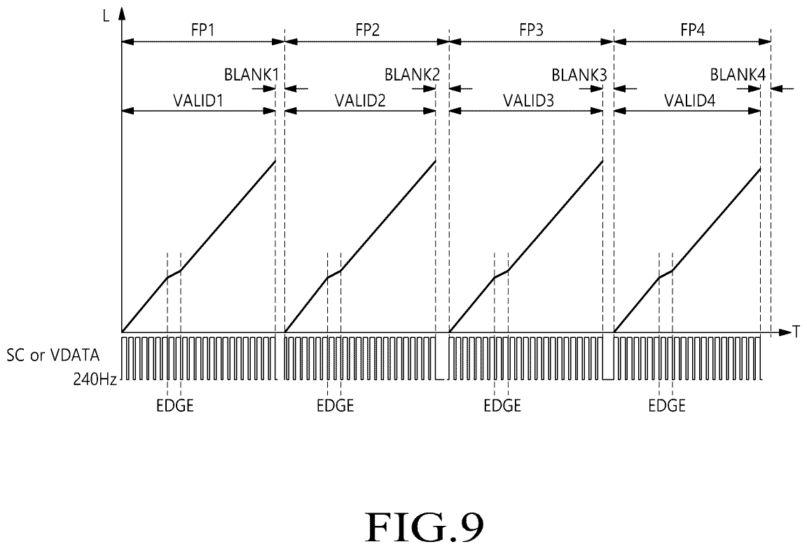

Hereinafter, other driving methods implemented in the same display device 100 can be illustrated, such as normal driving (FIG. 7), DFR driving (FIG. 8), and Dynamic DFR driving (FIG. 9). Accordingly, the time scale in FIG. 7 can be larger than the time scales in FIGS. 8 and 9. For example, the frame period in FIG. 7 can be twice the frame period in FIG. 8. Similarly, the frame period in FIG. 7 can be twice the frame period in FIG. 9. However, depending on the adjustment of the frame period (or blank period) in FIG. 9, which will be described later, the frame period in FIG. 7 can be less than twice the frame period in FIG. 9. Additionally, the number of pulses corresponding to the number of times the scan signal SC and the data voltage VDATA are supplied in FIGS. 7-9 is exemplary.

Hereinafter, the driving periods of normal driving (FIG. 7), DFR driving (FIG. 8), and Dynamic DFR driving (FIG. 9) are described in relation to the compensation data (300, 500, 600) used to compensate multiple subpixels SP within the same display device 100.

FIG. 7 is a chart illustrating the driving periods of the display device 100, in which multiple subpixels SP are driven in units of a single line, according to various embodiments of the present disclosure. Referring to FIG. 7, the horizontal axis of the chart represents time (T), and the vertical axis represents the number of lines in which multiple subpixels SP are arranged. The chart in FIG. 7 illustrates the driving periods of the display device 100 operating in a normal driving mode.

In the normal driving mode, the frame rate of the display panel 110 in the display device 100 can remain constant. In particular, the frame rate can refer to the number of frames per second. For example, the frame rate can be 120 Hz. However, this is merely exemplary, and the display device 100 can have a different frame rate. Since the frame rate is constant, the frame period (FP) can also remain constant (i.e., frame period is the reciprocal of the frame rate).

In addition, the frame period can include an active period and a blank period. In particular, the active period can be referred to as the vertical valid (VERTICAL VALID) period, and the blank period can be referred to as the vertical blank (VERTICAL BLANK) period. Further, the driving period of the display device 100 can include multiple frame periods (FP1, FP2, FP3, FP4).

For example, the multiple frame periods can include a first frame period FP1, a second frame period FP2, a third frame period FP3, and a fourth frame period FP4. As shown, the first frame period FP1 can include a first active period VALID1 and a first blank period BLANK1, the second frame period FP2 can include a second active period VALID2 and a second blank period BLANK2, the third frame period FP3 can include a third active period VALID3 and a third blank period BLANK3, and the fourth frame period FP4 can include a fourth active period VALID4 and a fourth blank period BLANK4.

During the active period, the scan signal SC at a turn-on level and the data voltage VDATA are supplied, allowing an image to be displayed on the display panel 110. During the blank period, since the data voltage VDATA is not supplied, the image is not displayed. As the frame period progresses, the scan signal SC at a turn-on level can be sequentially supplied in units of lines of multiple subpixels SP arranged in a matrix format. The multiple subpixels SP arranged in the lines where the scan signal SC at a turn-on level is sequentially supplied can receive the data voltage VDATA.

In addition, the data voltage VDATA can include a compensated data voltage VDATA_COMP. That is, in the normal driving mode, the display device 100 can supply the compensated data voltage VDATA_COMP, which is compensated using the first compensation data 300, sequentially in units of a single line to multiple subpixels SP. As the frame period progresses, the number of lines L in which the data voltage VDATA is supplied and the image is actively displayed can increase. While an image containing multiple frames are displayed on the display device 100, the driving period of the display device 100 can consist of repeated frame periods.

Hereinafter, the DFR driving method is described, in which multiple subpixels SP are driven in units of two or more lines, increasing the frame rate and reducing the frame period. In particular, FIG. 8 is a chart illustrating the driving periods of the display device 100, in which multiple subpixels SP are driven in units of two or more lines, according to various embodiments of the present disclosure. Referring to FIG. 8, the horizontal axis of the chart represents time (T), and the vertical axis represents the number of lines L in which multiple subpixels SP are arranged. The chart in FIG. 8 illustrates the driving periods of the display device 100 operating in the DFR driving mode.

In the DFR driving mode, the frame rate of the display device 100 can remain constant. For example, if the frame rate in the normal driving mode, in which subpixels SP are driven in units of a single line, is 120 Hz, the frame rate in the DFR driving mode, in which subpixels SP are driven in units of two or more lines, can be 240 Hz.

The above is merely exemplary, and the display device 100 can have a different frame rate. Since the frame rate remains constant, the frame period (Frame Period, FP) also remains constant. That is, the frame period is the reciprocal of the frame rate. Accordingly, the length of the frame periods in FIG. 8 can be half the length of the frame periods in FIG. 7. As shown, the frame period can include an active period and a blank period.

During the active period, a scan signal SC at a turn-on level and a data voltage VDATA can be supplied in units of two or more lines to multiple subpixels SP, allowing an image to be displayed on the display panel 110. During the blank period, as the data voltage VDATA is not supplied, the image can not be displayed. As the frame period progresses, a scan signal SC at a turn-on level can be sequentially supplied in units of two or more lines to multiple subpixels SP arranged in a matrix format. Also, the multiple subpixels SP arranged in the lines where the scan signal SC at a turn-on level is sequentially supplied can receive the data voltage VDATA.

In addition, the data voltage VDATA can include a compensated data voltage VDATA_COMP. That is, in the DFR driving method, the display device 100 can supply the compensated data voltage VDATA_COMP, which is compensated using the DFR compensation data 500, sequentially in units of two or more lines to multiple subpixels SP. As the frame period progresses, the number of lines L where the data voltage VDATA is supplied and the image is actively displayed can increase.

Further, the driving period of the display device 100 can include multiple frame periods FP1, FP2, FP3, and FP4. Alternatively, during the display of an image containing multiple frames, the driving period of the display device 100 can include repeated frame periods.

Hereinafter, the Dynamic DFR driving method are described.

In particular, FIG. 9 is a chart illustrating the driving periods of the display device 100, in which multiple subpixels SP are driven in units of a single line or two or more lines, according to various embodiments of the present disclosure. Referring to FIG. 9, the horizontal axis of the chart represents time (T), and the vertical axis represents the number of lines L in which multiple subpixels SP are arranged. The chart in FIG. 9 illustrates the driving periods of the display device 100, which is driven using the Dynamic DFR driving method.

During the frame period in the Dynamic DFR driving mode, as multiple subpixels SP are driven in units of a single line or two or more lines, the length of the active period can increase, and the blank period can be shortened compared to the DFR driving method, where multiple subpixels SP are driven in units of two or more lines.

For example, in the Dynamic DFR driving mode, the length of the frame periods can be set differently by extending the blank period to secure sufficient blank time and delaying the start time of the next active period. During the active period, a scan signal SC at a turn-on level and a data voltage VDATA can be supplied in units of a single line or two or more lines to multiple subpixels SP, allowing an image to be displayed on the display panel 110. During the blank period, since the data voltage VDATA is not supplied, the image can not be displayed.

As the frame period progresses, a scan signal SC at a turn-on level can be sequentially supplied in units of a single line or two or more lines to multiple subpixels SP arranged in a matrix format. Once the scan signal SC at a turn-on level is sequentially supplied, multiple subpixels SP can receive the data voltage VDATA.

In addition, the data voltage VDATA can include a compensated data voltage VDATA_COMP. That is, in the Dynamic DFR driving mode, the display device 100 can supply the compensated data voltage VDATA_COMP, which is compensated using the second compensation data 600, sequentially in units of a single line or two or more lines to multiple subpixels SP.

As the frame period progresses, the number of lines L where the data voltage VDATA is supplied and the image is actively displayed can increase. In this instance, the number of detected edges corresponds to the number of times subpixels SP are driven in units of a single line. Since there are instances where subpixels SP are driven in units of a single line, the time required to display an entire frame in the Dynamic DFR driving mode can be longer than that required in the DFR driving mode. As the time required to display an entire frame increases while the frame time remains constant, the active period VALID can increase, and the blank period can decrease.

During the blank period, operations used for the driving of the display device 100, such as touch driving and pixel sensing, can be performed. As the blank period decreases, a problem can arise where other operations, excluding image display, are not adequately performed in the display device 100. To solve the aforementioned issue, a method of extending the blank period or adjusting the lengths of other blank periods to compensate for the extended blank period can be used.

For example, if the gate driving circuit 120 supplies a scan signal SC in units of a single line during the first active period VALID1, in which the scan signal SC is supplied to all lines of multiple subpixels SP, the first blank period BLANK1 can be extended by a first period, and the start time of the subsequent second active period VALID2 can be delayed. For example, the first period can be proportional to the number of times the Dynamic DFR driving mode drives in units of a single line (i.e., the number of times a scan signal SC is supplied in units of a single line). The first period can be a predetermined duration that is proportional to the number of times the Dynamic DFR driving mode operates in units of a single line (i.e., the number of times a scan signal SC is supplied in units of a single line).

In addition, the display device 100 can shorten at least one of the multiple blank periods (BLANK2, BLANK3, BLANK4) following the first blank period (BLANK1) by the first period. For example, in the DFR driving method, where multiple subpixels SP are driven only in units of two or more lines, the first active period VALID1 can be 3.3 ms, and the first blank period BLANK1 can be 0.8 ms. In the Dynamic DFR driving method, as lines containing edges are driven in units of a single line, the first active period VALID1 can be extended to 3.4 ms, and the first blank period BLANK1 can be shortened to 0.7 ms. Accordingly, the display device 100 can extend the first blank period BLANK1 by 0.1 ms and delay the start time of the second active period VALID2 by 0.1 ms.

To compensate for the extended time in the first blank period BLANK1, the display device 100 can shorten the second blank period VALID2, the third blank period BLANK3, or the fourth blank period BLANK4 by 0.1 ms after the first blank period BLANK1. In this instance, since the sensing and compensation of the display device 100 progress while the image is being displayed, the number of edges between frame periods can vary. Depending on the number of edges between frame periods, the blank period to be shortened can be determined.

For example, the display device 100 can shorten two or more blank periods among multiple blank periods BLANK2, BLANK3 and BLANK4 following the first blank period BLANK1. The first period can be the total duration obtained by summing the shortened durations of each of the two or more blank periods. The shortened durations of each of the two or more blank periods can be the same or can have different lengths.

Further, in the DFR driving method, where multiple subpixels SP are driven in units of two or more lines, the first active period VALID1 can be 3.3 ms, and the first blank period BLANK1 can be 0.8 ms. In the Dynamic DFR driving method, as lines containing edges are driven in units of a single line, the first active period VALID1 can be extended to 3.4 ms, and the first blank period BLANK1 can be shortened to 0.7 ms. The display device 100 can extend the first blank period BLANK1 by 0.1 ms and delay the start time of the second active period (VALID2) by 0.1 ms.

Accordingly, to compensate for the extended time in the first blank period BLANK1, the display device 100 can shorten the subsequent second blank period VALID2 and the third blank period VALID3 by 0.05 ms each. In this instance, since the sensing and compensation of the display device 100 progress while the image is being displayed, the number of edges between frame periods can vary. Depending on the number of edges between frame periods, the blank period to be shortened and the amount of time to be shortened from each blank period can be determined. The aforementioned operations of the display device 100 can be performed under the control of the controller 140. Hereinafter, the operations of the controller 140 are described.

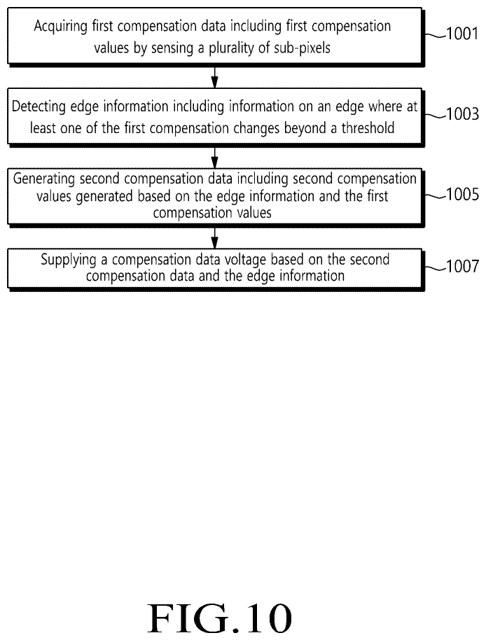

Next, FIG. 10 is a flowchart illustrating a compensation method for the display device 100 according to various embodiments of the present disclosure. Referring to FIG. 10, in step 1001, the controller 140 can acquire first compensation data 300, which includes first compensation values, by sensing multiple subpixels SP.

That is, the controller 140 can control the application of a sensing driving voltage to multiple subpixels SP, thereby acquiring first compensation data 300, which includes first compensation values corresponding to the sensing values which correspond to the voltages of respective sensing lines SIOL. In step 1003, the controller 140 can detect edge information 400, which contains information about edges where at least one of the first compensation values changes beyond a threshold value.

For example, the controller 140 can sequentially compare the first compensation values of lines within the first compensation data 300 to detect an edge. The controller 140 can also detect an edge by comparing the difference between the first compensation values positioned in the same column across adjacent lines. If the difference value exceeds a preset threshold value, the controller 140 can determine that an edge has been detected. If the difference value is below the preset threshold value, the controller 140 can determine that no edge has been detected. The edge information 400 corresponding to a detected edge can have a value of 1, while the edge information 400 corresponding to a line where no edge is detected can have a value of 0.

In step 1005, the controller 140 can generate second compensation data 600, which includes second compensation values, based on the edge information 400 and the first compensation values. For example, the controller 140 can sequentially compare the first compensation values in units of two or more lines within the first compensation data 300 to generate edge information 400. If at least two lines are determined to be lines where no edge is detected (or if the edge information 400 for at least two lines has a value of 0), the controller 140 can generate representative values of the first compensation values in those lines as second compensation values within a single line of the second compensation data 600.

In addition, the controller 140 can sequentially compare the first compensation values in units of at least two lines within the first compensation data 300 to generate edge information 400. If at least two lines are determined to be lines where an edge is detected (or if the edge information 400 for at least two lines has a value of 1), the controller 140 can generate the first compensation values of each detected edge line as the second compensation values of each corresponding lines in the second compensation data.

In step 1005, the controller 140 can supply a compensation data voltage VDATA_COMP based on the edge information 400 and the second compensation data 600. For example, the controller 140 can control the output of the compensation data voltage VDATA_COMP based on the edge information 400. The voltage is compensated using the second compensation values generated as representative values for multiple subpixels SP in at least two lines within the display panel 110. In this instance, based on the edge information 400, the controller 140 can control the display panel 110 so that while the compensation data voltage VDATA_COMP, compensated using the second compensation values generated as representative values for multiple subpixels SP in at least two lines within the display panel 110, is being output, a scan signal SC at a turn-on level is supplied in units of two or more lines within the display panel 110, and the compensation data voltage VDATA_COMP is supplied.

Also, based on the edge information 400, the controller 140 can control the output of compensation data voltages VDATA_COMP, which are compensated using second compensation values generated from the first compensation values for multiple subpixels SP in at least two lines within the display panel 110. In this instance, based on the edge information 400, the controller 140 can control the display panel 110 so that, while the compensation data voltages VDATA_COMP, compensated using the second compensation values generated from each of the first compensation values for multiple subpixels SP in at least two lines within the display panel 110, are being output, a scan signal SC at a turn-on level is supplied in units of a single line within the display panel 110, and the compensation data voltage VDATA_COMP is supplied.

In addition, the compensation data voltage VDATA_COMP can be an analog voltage derived from the digital compensation image data DATA_COMP output by the controller 140 within the data driving circuit 130. Accordingly, the compensated data voltages, obtained from the second compensation data 600 generated based on the sensing values, can be supplied to multiple subpixels SP at the appropriate locations.

Further, the display device according to various embodiments of the present disclosure can be described as follows. In particular, the display device can include a display panel in which multiple subpixels are arranged, a data driving circuit that supplies data voltage to the multiple subpixels, and a controller that controls the data driving circuit.

The controller can acquire first compensation data that includes first compensation values, which compensate for the characteristic values of each of the multiple subpixels, by sensing the multiple subpixels. The controller can also detect edge information that includes information about an edge where at least one of the first compensation values changes beyond a threshold value.

Further, the controller can generate second compensation data, which includes second compensation values generated based on the edge information and the first compensation values. The controller can also supply a compensation data voltage based on the second compensation data and the edge information. In addition, the first compensation data can correspond to the arrangement of multiple subpixels arranged in a matrix format.

The controller can also sequentially compare the first compensation values in units of at least two lines within the first compensation data to generate edge information. If at least two lines are determined to be lines where no edge is detected, the representative values of the first compensation values in those lines can be generated as the second compensation values within a single line of the second compensation data. Based on the edge information, the controller can control the output of the compensation data voltage, which is compensated using the second compensation values generated as representative values for multiple subpixels in at least two lines within the display panel.

In addition, the display device can further include a gate driving circuit that supplies a scan signal. Based on the edge information, the controller that controls the gate driving circuit can ensure that, while the compensation data voltage compensated using the second compensation values generated as representative values for multiple subpixels in at least two lines within the display panel is being output, a scan signal at a turn-on level is supplied in units of at least two lines within the display panel, and the compensation data voltage is supplied.

In addition, the controller can generate the edge information by sequentially comparing the first compensation values in units of at least two lines within the first compensation data. Based on the edge information, if at least two lines are determined to be lines where an edge is detected, the controller can generate the first compensation values of each detected edge line as the second compensation values of each corresponding line in the second compensation data.

Based on the edge information, the controller can control the output of compensation data voltages, which are compensated using the second compensation values generated from each of the first compensation values for multiple subpixels in at least two lines within the display panel. The display device can further include a gate driving circuit that supplies a scan signal.

Also, the controller, which controls the gate driving circuit, can, based on the edge information, ensure that while the compensation data voltages compensated using the second compensation values generated from each of the first compensation values for multiple subpixels in at least two lines within the display panel are being output, a scan signal at a turn-on level is supplied in units of a single line within the display panel and the compensation data voltage is supplied.

Further, the display device can include a display area where multiple subpixels arranged in lines and images are displayed, a non-display area that defines the boundary of the display area, a gate driving circuit positioned in the non-display area that supplies scan signals to multiple subpixels in units of at least two lines or a single line, and a controller that controls the data driving circuit.

As multiple frames of an image are displayed, the operation period of the controller can repeatedly alternate between multiple valid periods, during which images are displayed in multiple frame periods, and multiple blank periods, during which images are not displayed in multiple frame periods. During the first valid period, in which scan signals are supplied to all lines of multiple subpixels, if the gate driving circuit supplies a scan signal in units of a single line, the controller can extend the first blank period by a first period and delay the start time of the second valid period following the first blank period.

Also, the controller can shorten at least one of the blank periods following the first blank period by the first period. In addition, controller can shorten each of two or more blank periods following the first blank period. The first period can be the total duration obtained by summing the durations of each of the two or more shortened blank periods. Each of the two or more blank periods, when shortened, can have the same duration or different durations.

A method of driving a display apparatus including a display panel in which a plurality of subpixels are arranged, a data driving circuit supplying data voltages to the plurality of subpixels, a gate driving circuit supplying scan signals, and a controller controlling the data driving circuit, includes the steps of obtaining first compensation data that includes first compensation values that compensate for the characteristic values of each of the plurality of subpixels, based on sensing the plurality of subpixels, detecting edge information that includes information about an edge where at least one of the first compensation values changes by at least a threshold amount, generating second compensation data that includes edge information and second compensation values generated based on the first compensation values, and supplying compensation data voltages based on the second compensation data and the edge information. The first compensation data can correspond to the arrangement pattern of the plurality of subpixels arranged in a matrix format.

The step of generating second compensation data that include second compensation values generated based on edge information and the first compensation values, can further include a step of comparing the first compensation values in at least two lines sequentially within the first compensation data to generate edge information, and, if at least two lines are determined to be lines where no edge is detected, generating representative values of the first compensation values in the at least two lines as second compensation values within a single line of the second compensation data.

Also, the step of supplying compensation data voltages based on the second compensation data and edge information can further include a step of controlling the output of compensation data voltages that are compensated using second compensation values, which are generated as representative values, for at least two lines of multiple subpixels in the display panel, based on the edge information. Further, the step of supplying compensation data voltages based on the second compensation data can further include a step of supplying turn-on level scan signals to at least two lines of the display panel to control the output of compensation data voltages, while compensation data voltages, which are compensated using second compensation values generated as representative values for at least two lines of multiple subpixels in the display panel, are being output.

Also, the step of generating second compensation data, which includes second compensation values generated based on edge information and first compensation values, can further include a step of comparing the first compensation values in at least two lines sequentially within the first compensation data to generate edge information, and, based on the edge information, if at least two lines are determined to be lines where an edge is detected, generating each first compensation value in the at least two lines where the edge is detected as a second compensation value for the corresponding at least two lines in the second compensation data.

Further, the step of supplying compensation data voltages based on the second compensation data and edge information can further include a step of controlling the output of compensation data voltages so that, based on the edge information, compensation data voltages that are compensated using second compensation values, each generated from the corresponding first compensation value for at least two lines of multiple subpixels in the display panel, are output.

Also, the step of supplying compensation data voltages based on the second compensation data and edge information can further include a step of supplying turn-on level scan signals to a unit of a single line within the display panel to control the output of the compensation data voltages, while compensation data voltages, which are compensated using second compensation values generated from the corresponding first compensation value for at least two lines of multiple subpixels in the display panel based on the edge information, are being output.

The above description has been presented to enable any person skilled in the art to make and use the technical idea of the present invention, and has been provided in the context of a particular application and its requirements. Various modifications, additions and substitutions to the described embodiments will be readily apparent to those skilled in the art, and the general principles defined herein can be applied to other embodiments and applications without departing from the spirit and scope of the present invention. The above description and the accompanying drawings provide an example of the technical idea of the present invention for illustrative purposes only. That is, the disclosed embodiments are intended to illustrate the scope of the technical idea of the present invention.

What is claimed is:

1. A display device comprising:
a display panel including a plurality of sub-pixels;
a data driving circuit configured to supply data voltages to the plurality of sub-pixels; and
a controller configured to:
sense the plurality of sub-pixels and obtain first compensation data including first compensation values for compensating characteristic values of each of the plurality of sub-pixels based on the sensed plurality of pixels;
detect edge information about an edge where a difference between first compensation values positioned in a same column across adjacent lines changes beyond a threshold;
generate second compensation data including second compensation values generated based on the edge information and the first compensation values; and
supply compensation data voltages to the plurality of sub-pixels based on the second compensation data and the edge information.

2. The display device of claim 1, wherein the first compensation data is stored in a matrix form and corresponds to an arrangement of the plurality of sub-pixels.

3. The display device of claim 2, wherein the controller is further configured to:
sequentially compare the first compensation values in units of at least two lines within the first compensation data to detect the edge information, and
if the compared at least two lines are determined to be lines where no edge is detected, generate representative values of each of the first compensation values in the at least two lines where no edge is detected, as second compensation values within a single line of the second compensation data.

4. The display device of claim 3, wherein the controller is further configured to:
supply the compensation data voltages compensated using the second compensation values, which are generated as the representative values, for at least two lines of multiple sub-pixels in the display panel, based on the edge information.

5. The display device of claim 4, further comprising:
a gate driving circuit configured to supply scan signals,
wherein the controller is further configured to:
control the gate driving circuit to supply the scan signals at a turn-on level to at least two lines in the display panel to control the supply of the compensation data voltages, while the compensation data voltages, which are compensated using second compensation values generated as the representative values for at least two lines of multiple sub-pixels in the display panel based on the edge information, are being supplied.

6. The display device of claim 1, wherein the controller is further configured to:
sequentially compare the first compensation values in units of at least two lines within the first compensation data to detect the edge information, and
if at least two lines are determined to be lines where an edge is detected, generate the first compensation values of each of the at least two lines where the edge is detected, as the second compensation values of at least two lines in the second compensation data.

7. The display device of claim 6, wherein the controller is further configured to:
supply the compensation data voltages compensated using the second compensation values for at least two lines of multiple sub-pixels in the display panel, based on the edge information.

8. The display device of claim 7, further comprising:
a gate driving circuit configured to supply scan signals,
wherein the controller is further configured to:
control the gate driving circuit to supply the scan signals at a turn-on level to a unit of a single line within the display panel to control the output of the compensation data voltages, while the compensation data voltages using second compensation values generated for at least two lines of multiple sub-pixels in the display panel based on the edge information, are being supplied.

9. A display device comprising:
a display area including a plurality of sub-pixels arranged in lines;
a non-display area defining an outer region of the display area;
a gate driving circuit disposed in the non-display area and configured to supply scan signals to the plurality of sub-pixels in units of at least two lines or a single line; and
a controller configured to:
alternate between multiple valid periods during which a plurality of frames of an image are displayed and multiple blank periods during which the image is not displayed,
extend a first blank period by a preset first period proportional to a number of times a scan signal was supplied in a unit of a single line, depending on whether the gate driving circuit has supplied scan signals in units of a single line, during a first valid period in which scan signals were supplied to all lines of the plurality of sub-pixels, and
delay a start time of a second valid period following the first blank period.

10. The display device of claim 9, wherein the controller is further configured to:
shorten at least one of the plurality of blank periods following the first blank period by the first period.

11. The display device of claim 10, wherein the controller is further configured to:
shorten each of at least two or more blank periods following the first blank period, and
wherein the first period is equal to a sum of the shortened periods of the at least two or more blank periods, and each of the shortened periods is a same or different length.

12. A method of driving a display device, the method comprising:
sensing a plurality of sub-pixels of the display device;
obtaining first compensation data including first compensation values for compensating characteristic values of each of the plurality of sub-pixels based on the sensed plurality of sub-pixels;
detecting edge information about an edge where a difference between first compensation values positioned in a same column across adjacent lines changes beyond a threshold;
generating second compensation data including second compensation values generated based on the edge information and the first compensation values; and
supplying compensation data voltages to the plurality of sub-pixels based on the second compensation data and the edge information.

13. The method of driving of claim 12, wherein the first compensation data is stored in a matrix form and corresponds to an arrangement of the plurality of sub-pixels.

14. The method of driving of claim 13, wherein the generating the second compensation data comprises:
sequentially comparing the first compensation values in units of at least two lines within the first compensation data to detect the edge information; and
if the compared at least two lines are determined to be lines where no edge is detected based on the generated edge information, generating representative values of each of the first compensation values in the at least two lines where no edge is detected, as the second compensation values within a single line of the second compensation values within a single line of the second compensation data.

15. The method of driving of claim 14, wherein the supplying compensation data voltages based on the second compensation data and the edge information includes:
supplying the compensation data voltages compensated using the second compensation values, which are generated as the representative values, for at least two lines of multiple sub-pixels in the display panel, based on the edge information.

16. The method of driving of claim 15, wherein the supplying the compensation data voltages based on the second compensation data comprises:
supplying the scan signals at a turn-on level to at least two lines of the display panel to control the supply of the compensation data voltages, while the compensation data voltages, which are compensated using second compensation values generated as the representative values for at least two lines of multiple sub-pixels in the display panel based on the edge information, are being supplied.

17. The method of driving of claim 12, wherein the generating the second compensation data comprises:
sequentially comparing the first compensation values in units of at least two lines within the first compensation data to detect the edge; and
if at least two lines are determined to be lines where an edge is detected, generating the first compensation values of each of the at least two lines where the edge is detected as the second compensation values of at least two lines in the second compensation data.

18. The method of driving of claim 17, wherein the supplying compensation data voltages based on the second compensation data and the edge information comprises:
controlling the supply of the compensation data voltages compensated using second compensation values, for at least two lines of multiple sub-pixels in the display panel, based on the edge information.

19. The method of driving claim 18, wherein the supplying the compensation data voltages based on the second compensation data and the edge information includes:
supplying scan signals at a turn-on level to a unit of a single line to control the supply of the compensation data voltages, while the compensation data voltages using second compensation values generated for at least two lines of multiple sub-pixels in the display panel based on the edge information, are being supplied.

20. A display device comprising:
a display panel including a plurality of sub-pixels arranged in a matrix form with column and rows;
and
a controller configured to:
detect a difference between first compensation values positioned in a same column across adjacent lines that changes beyond a threshold; and
supply the data voltages to the plurality of subpixels compensated based second compensation values generated based on the detected difference of the first compensation values positioned in the same column across adjacent lines that changes beyond the threshold.
